(19) United States
(12) Patent Application Publication
(10) Pub. No.: US 2003/0229486 A1
(43) Pub. Date: Dec. 11, 2003

(54) System level simulation method and device

(75) Inventor: Yoshiyuki Ito, Tokyo (JP)

Correspondence Address: SUGHRUE MION, PLLC, 2100 Pennsylvania Avenue, NW, Washington, DC, 20037-3213, US

(73) Assignee: NEC CORPORATION

(21) Appl. No.: 10/419,151

(22) Filed: Apr. 21, 2003

Related U.S. Application Data
(63) Continuation-in-part of application No. 09/299,568, filed on Apr. 27, 1999, now abandoned.

(30) Foreign Application Priority Data
Apr. 28, 1998 (JP) 10-134560

(51) Int. Cl. G06F 9/455

(52) U.S. Cl. 703/27

(57) ABSTRACT

The system level simulation method of the present invention comprises the steps of: dividing the simulation target device into a first circuitry portion and a second circuitry portion; emulating the first circuitry portion by an emulation subject circuit constructed by a rewritable hardware; simulating the second circuitry portion by a partial circuit process substitute section constructed by software; and allowing communication of data between the emulation subject circuit and the partial circuit process substitute section.

### BACKGROUND OF THE INVENTION

1. Field of the Invention

The present invention relates to a system level simulation method and device which includes an operation of an input/output device of a computer, and in particular, to a technique for emulating a simulation target device using a rewritable hardware.

This application claims priority to Japanese Patent Application No. 10-134560, filed on Apr. 28, 1998, and is a Continuation-in-Part of U.S. patent application Ser. No. 09/299,568, filed Apr. 27, 1999.

2. Description of the Related Art

Japanese Patent Application, First Publication No. Hei 8-110919 discloses an example of a conventional system level simulation device for simulating a simulation target device in a computer system.

FIG. 9 is a block diagram showing the construction of the system level simulation device 5, which includes an instruction level simulator 51 and a logic level simulator 52 which are realized by software.

The instruction level simulator 51 operates faster than the logic level simulator 52, but cannot accurately simulate an entire system which includes an input/output device. In contrast, the logic level simulator 52 can perform an accurate simulation, but operates at a very low speed.

FIG. 10 is a block diagram showing an example of the computer system to be simulated by the system level simulation device 5. The computer system includes a host system 6 and an input/output system 7.

The operation of the conventional system level simulation device 5 will be explained with reference to FIGS. 9 and 10.

The instruction level simulator 51 simulates a processor 61, a system bus 62, a memory 63, and an interface 64 in the host system 6, to simulate the main portion of the computer system. The logic level simulator 52 simulates an input/output manager 72 in the input/output system 7 and performs the input/output operation required for the system level simulation.

Further, using a socket module 65 in the host system 6 simulated by the instruction level simulator 51 and a socket interface 71 simulated by the logic level simulator 52, the host system 6 and the input/output system 7 send the contents of the operations between each other. Thus, the simulation of the system level is carried out.

In the conventional system level simulation device 5 shown in FIG. 9, the instruction level simulator 51 whose processing speed is high simulates the host system 6, while the logic level simulator 51 simulates the input/output system 7 which cannot be accurately simulated by the instruction level simulator 51, thereby improving the speed of the system level simulation.

However, the improvement of the processing speed is limited because the conventional system level simulation device 5 integrates both the instruction level simulator 51 and the logic level simulator 52 which are realized by the software.

Japanese Patent Publication, First Publication No. Hei 8-508599 discloses the technology of mapping the simulation target circuit in an FPGA (Field Programmable Gate Array) and performing the simulation using the same. The FPGA remarkably improves the processing speed, as compared with the technique using an instruction level simulator and the logic level simulator which are realized by software.

To improve the processing speed, an emulator using an FPGA may perform the system level simulation.

An emulator with an FPGA performs the system level simulation significantly faster than the system level simulation device of FIG. 9.

However, there is a problem with an emulator with an FPGA, which will be discussed below:

At the time of computer system development, a system level simulation is often required even though the specifications of a part of the host system is not fixed, but an emulator with an FPGA which can emulate the operations of all the elements in the computer system must be prepared. For example, even when the specifications of the elements other than the processor in the computer system are not fixed, it is necessary to build an emulator which can emulate all the elements such as a system bus and a memory.

It takes much time and labor to build an emulator with an FPGA. Preparing an emulator with an FPGA for the elements whose specifications are not fixed involves the risk of being labor- and time-consuming, and the system level simulation may not be executed efficiently. That is, when the provisional specification of the element, for which the emulator is built, differs from the specification fixed later, another emulator must be produced, resulting in an inefficient system level simulation. Further, because the processing speed of the emulator with the FPGA differs from that of the emulation target device, it is difficult to perform the operation and the management of the input/output device and other devices which are externally added to the emulation target device. Therefore, the external input/output device must be included in the emulation target, or an interface for matching the processing speeds must be provided, and this is a cause of increased labor to produce the emulator.

### SUMMARY OF THE INVENTION

It is therefore an object of the present invention to provide a system level simulation method and device for performing the simulation efficiently and quickly.

The system level simulation method for simulating a simulation target device of the present invention, comprises the steps of: dividing the simulation target device into a first circuitry portion and a second circuitry portion; emulating the first circuitry portion by an emulation subject circuit constructed by a rewritable hardware; simulating the second circuitry portion by a partial circuit process substitute section constructed by software; and allowing communication of data between the emulation subject circuit and the partial circuit process substitute section.

The system simulation method of the present invention further comprises the step of: calling an operating system from the partial circuit process substitute section; and simulating the input/output process of the second circuitry portion using the operating system. The rewritable hardware is an FPGA.

The present invention provides the communication means for sending and receiving data required for the simulation between the emulation subject circuit and the partial circuit process substitute section. Therefore, the boundary between the first circuitry portion emulated by the emulation subject circuit and the second circuitry portion simulated by the partial circuit process substitute section can be freely adjusted. That is, every time a new additional specification is decided, the structure for emulating the element whose specification is newly decided can be added to the emulator subject circuit, making the system level simulation efficient.

Further, the emulator subject circuit with the rewritable hardware such as the FPGA emulates the element whose specification is fixed, thus increasing the processing speed.

Furthermore, the OS simulates the input/output operation of the second circuitry portion, simplifying the structure of the partial circuit process substitute section.

In another aspect of the present invention, the system level simulation device for simulating a simulation target device comprises: an emulation subject circuit for emulating a first circuitry portion in the simulation target device, the emulation subject circuit being constructed by rewritable hardware; a partial circuit process substitute section for simulating a second circuitry portion in the simulating target device, the partial circuit process substitute section being constructed by software; and a communicator for communicating the data required for the simulation between the emulation subject circuit and the partial circuit process substitute section.

The system level simulation device further comprises: an operating system caller for calling an operating system which simulates the input/output process performed by the second circuitry portion. The rewritable hardware is an FPGA.

In the computer readable medium containing program instructions for simulating a simulation target device, the program instructions include instructions for performing the steps comprising: dividing the simulation target device into a first circuitry portion and a second circuitry portion; emulating the first circuitry portion by an emulation subject circuit constructed by a rewritable hardware; simulating the second circuitry portion by a partial circuit process substitute section constructed by software; and allowing communication of data between the emulation subject circuit and the partial circuit process substitute section by a communicator.

The program instructions include instructions for performing the step of realizing the partial circuit process substitute section and the communicator in a computer by software.

### BRIEF DESCRIPTION OF THE DRAWINGS

FIG. 1 is a block diagram showing an embodiment of the present invention.

FIG. 2 is a flow chart showing the operation of an embodiment of the present invention.

FIG. 3 is a diagram showing an example of the present invention.

FIG. 4 is a diagram illustrating a boundary connection between an emulator and a host computer according to an exemplary, non-limiting embodiment of the present invention.

FIG. 5 is a diagram illustrating communication between the emulator and the host computer according to an exemplary, non-limiting embodiment of the present invention.

FIG. 6 is a diagram illustrating an image format converting apparatus to be simulated according to an exemplary, non-limiting embodiment of the present invention.

FIG. 7 is a diagram illustrating a first phase of simulation of the apparatus in FIG. 6 according to the exemplary, non-limiting embodiment of the present invention.

FIG. 8 is a diagram illustrating a second phase of simulation of the apparatus in FIG. 6 according to the exemplary, non-limiting embodiment of the present invention.

FIG. 9 is a block diagram showing the related art.

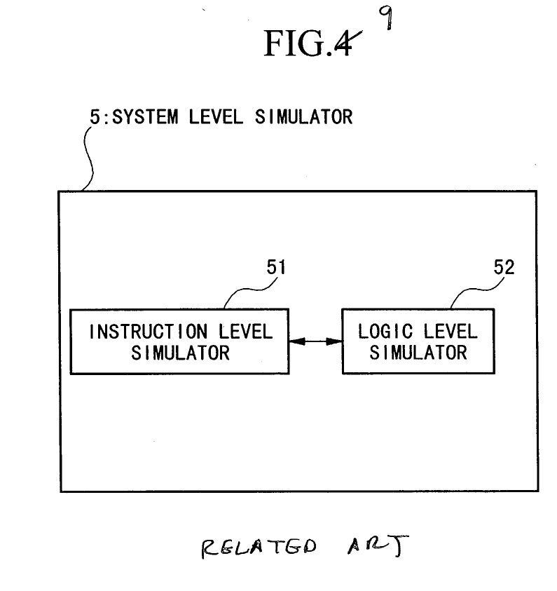

FIG. 10 is a block diagram explaining the operation of the related art.

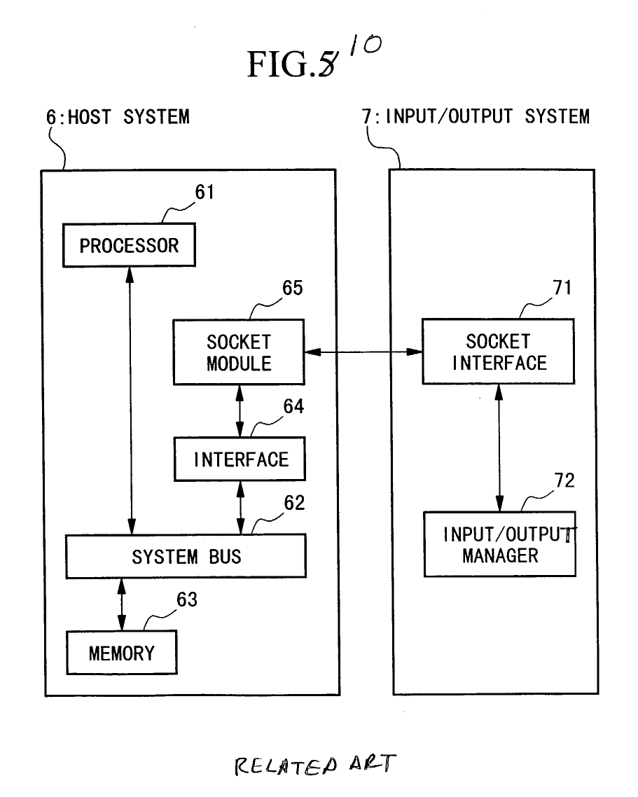

### DETAILED DESCRIPTION OF THE INVENTION

The best mode of the embodiment of the present invention will be explained.

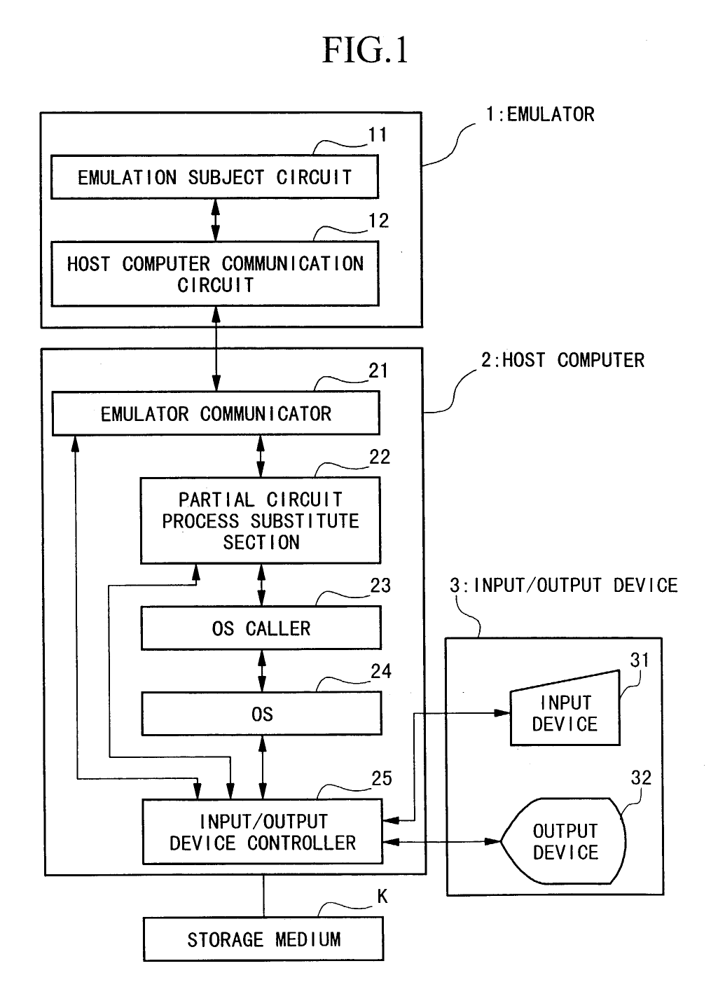

FIG. 1 is a block diagram showing the embodiment of the present invention, which includes an emulator 1 using rewritable hardware, a host computer 2 controlled by a computer program, an input/output device 3 which comprises an input device 31 such as a keyboard and an output device 32 such as a display, and a storage medium K.

The emulator 1 using the rewritable hardware has an emulation subject circuit 11 and a host computer communication circuit 12.

The emulation subject circuit 11, which is constructed by the rewritable hardware, performs equivalently to a part of the circuit (first circuitry portion) whose design specification is fixed and which can be emulated by the rewritable hardware. The rewritable hardware may be, for example, an FPGA. For example, the interface section communicating with the input/output device cannot be emulated by the rewritable hardware, because the operation speed of the input/output device differs from that of the rewritable hardware.

The host computer communication circuit 12 controls the operation of the emulation subject circuit 11 according to an instruction from the host computer 2, and notifies the host computer 2 of the content of the operation of the emulation subject circuit 11. The content of the operation may be an input request, an output request, a termination notification, and the status of a proceeding address in the computer system, which are issued by the first circuit portion emulated by the emulation subject circuit 11. The content of the operation can be extracted through the signal line connected to the corresponding section in the emulation subject circuit 11 of the FPGA.

The host computer 2 has an emulator communicator 21, a partial circuit process substitute section 22 performed by software, an OS (operating system) 24, an OS caller 23, and an input/output device controller 25.

On reception of the content of the operation sent from the emulator 1, the emulator communicator 21 sends the content to the partial circuit process substitute section 22 or operates the input/output device controller 25, and notifies the emulator 1 of the content of the control operation issued from the partial circuit process substitute section 22 to the emulation subject circuit 11.

The partial circuit process substitute section 22 simulates the other part of the simulation target circuit (the second circuitry portion), which is not emulated by the emulation subject circuit 11. Specifically, the partial circuit process substitute section 22 has functions of performing the processes corresponding to the content of the operations of the emulation subject circuit 11 sent from the emulator communicator 21, requesting the OS caller 23 to call the OS 24, and sending the content of the operation of controlling the emulation subject circuit 11 to the emulator communicator 21.

The OS caller 23 generates an argument corresponding to the content of the operation in response to the request sent from the partial circuit process substitute section 22, and, asynchronously with the process of the OS 24, sends the return value to the partial circuit process substitute section 22, assuming the content of the operation of the second circuitry portion.

The OS 24 directs the input/output device controller 25 to output the data to the output device 32, to store the data input from the input device 31, and to send the input data in response to the request from the OS caller 23, thus managing the input/output device 3.

The storage medium K connected to the host computer 2 may be a disc, a semiconductor memory, or other storage media, and stores the program for executing the system level simulation. The program is read by and controls the host computer 2 so as to realize the emulator communicator 21, the partial circuit process substitute section 22, and the OS caller 23 in the host computer 2.

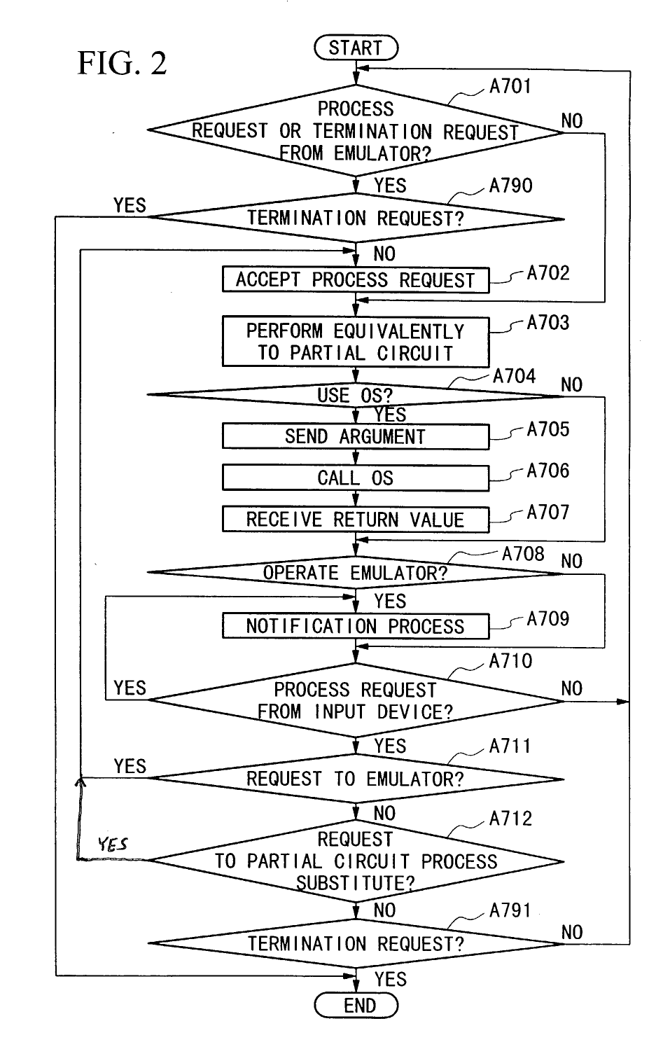

FIG. 2 is a flow chart showing the operation of the apparatus of FIG. 1. In the following, the operation of the embodiment of the present invention will be explained with reference to FIGS. 1 and 2.

The emulation subject circuit 11 in the emulator 1 successively emulates the operation of the first circuitry portion which is the emulation target, and notifies the content of the operation to the host computer 2 using the host computer communication circuit 12.

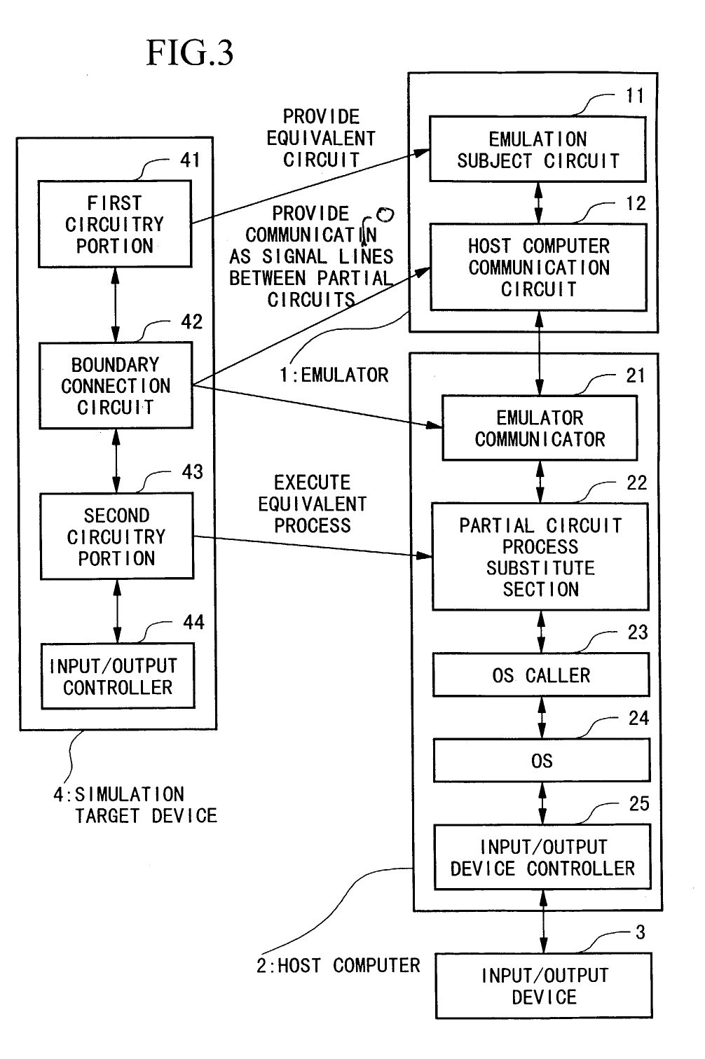

When the content of the operation of the first circuitry portion emulated by the emulation subject circuit 11 is informed to the host computer 2 through the host computer communication circuit 12 and the emulator communicator 21, the partial circuit process substitute section 22 analyzes the content of the operation, and determines whether the process request or the termination request is received from the emulation subject circuit 11 (step A701 in FIG. 3). When a process request such as the input request or the output request is received, the partial circuit process substitute section 22 accepts the request (step A702).

The partial circuit process substitute section 22 carries out the sequence equivalent to that of the second circuitry portion which is not emulated by the emulation subject circuit 11, and, when accepting the process request from the emulator 1, performs the process corresponding to the request (step A703).

When the partial circuit process substitute section 22, which performs the process of the second circuitry portion (step A703), requires the OS 24, the OS caller 23 sends the argument (step A705) to call the OS 24 (step A706), and receives the return value when the process under the OS 24 terminates (step A707).

By controlling the input/output device controller 25 in response to the call, the OS 24 stops and starts the input device 31 which is the keyboard, and outputs the data to the output device 32 which is the display.

When the partial circuit process substitute section 22, which performs the process of the second circuitry portion (step A703), is requested to control the emulator 1 (step A708), the partial circuit process substitute section 22 controls the emulation subject circuit 11 through the emulation communicator 21 and the host computer communication circuit 12 (step A710).

When the process request is received from the input device 31 of the keyboard, that is, when the OS 24 retains the process request sent from the input device 31 (step A710), the OS caller 23 determines whether the process request is to the emulator 1 or to the partial circuit process substitute section 22 (steps A711 and A712).

When the process request is to the emulator 1, the request is sent to the partial circuit process substitute section 22, which is then instructed to notify the emulator 1 (step A709). In contrast, when the process request is to the partial circuit process substitute section 22, the request is sent to the partial circuit process substitute section 22, which then performs the operation corresponding to the request (steps A702 and A703).

When the content of the operation sent from the emulator 1 includes the termination report (step A790), or when the process request input from the input device 31 of the keyboard is the termination request (step A791), the partial circuit process substitute section 22 terminates its process.

In the embodiment, both the emulation subject circuit 11 provided by the rewritable hardware and the partial circuit process substitute section 22 provided by the software in the host computer 2 are operated in a parallel processing manner, while sending and receiving the data required for the simulation through the host computer communication circuit 12 and the emulator communicator 21. Therefore, the first circuitry portion whose specification is fixed in the simulation target device is emulated by the emulation subject circuit 11, while the second circuitry portion, other than the first circuitry portion, can be simulated by the partial circuit process substitute 22, thereby making the system level simulation efficient.

The emulation subject circuit 11, which requires much time and labor to produce, has only to emulate the process of the first circuitry portion whose specification is fixed. As compared with the conventional method in which the emulation subject circuit emulates all elements in the simulation target device, the emulation subject circuit 11 can be produced quickly, thereby making the system level simulation efficient. Further, when an additional specification is decided, the structure for emulating the corresponding portion may be added to the emulation subject circuit 11. Therefore, as compared with the conventional method in which the emulation subject circuit emulates all elements in the simulation target device, the present invention avoids unnecessary change of the completed emulation subject circuit 11. Depending on the change of the emulation subject circuit 11, the partial circuit process substitute section 22 must be 25 modified, but can be easily adapted because it is provided by the software.

The operation of the present invention will be explained in detail with reference to an example.

As shown in FIG. 3, the simulation target device 4 is divided into the first circuitry portion 41, whose specification is fixed and can be emulated by the rewritable hardware, and the second circuitry portion 43 other than the first circuitry portion. Further, the connection between the first circuitry portion 41 and the second circuitry portion 43 is separated as shown by a boundary connection circuit 42.

To simulate the simulation target device 4, the emulator 1 packages the emulation subject circuit 11 which is provided by the rewritable hardware and performs equivalently to the first circuitry portion 41. The host computer 2 provides a partial circuit process substitute section 22 which performs equivalently to the second circuitry portion 43 and is provided by the software.

The emulation subject circuit 11 in the emulator 1 carries out the process of the first circuitry portion 41.

On the other hand, the partial circuit process substitute section 22 in the host computer 2 carries out the process of the second circuitry portion 43 (step A703).

The data transmission between the first circuitry portion 41 and the second circuitry portion 43 is realized by the communication between the emulation subject circuit 11 and the partial circuit process substitute section 22 through the host computer communication circuit 12 and the emulator communicator 21.

The operation in which the second circuitry portion 43 in the simulation target device 4 controls the input/output controller 44, can be simulated by operating the input/output device controller 25 from the partial circuit process substitute section 22 through the OS caller 23 and the OS 24 (steps A705 to A707).

While in this embodiment, the operation in which the second circuitry portion 43 controls the input/output controller 44 is simulated by the OS 24, the partial circuit process substitute section 22 may simulate the operation. In this case, the process performed by the OS 24 must be incorporated in the partial circuit process substitute section 22. This may lengthen the time required to produce the partial circuit process substitute section 22, and therefore, the construction of the above embodiment is preferable.

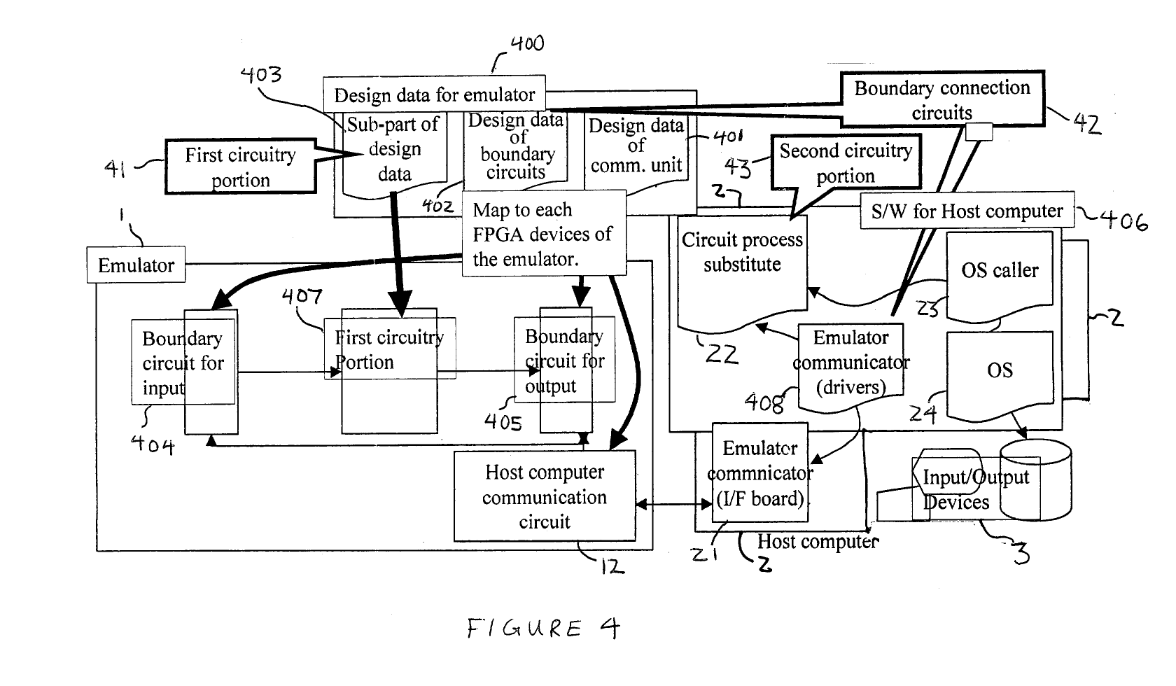

FIGS. 4-8 illustrate additional non-limiting features enabling the present invention. FIG. 4 illustrates a boundary between the emulator 1 and the host computer 2. As described above, the emulator 1 includes the host computer communication circuit 12 connected to the emulator communicator 21 in hardware (i.e., an I/F board) of the host computer 2. The host computer 2 includes the operating system (OS) 24 and the operating system caller 23, which is coupled between the OS 24 and the partial circuit process substitute section 22. The input/output devices 3 are connected to the host computer 2. An emulator communicator in software (e.g., the drivers) 408 is coupled between the emulator communicator 21 and the partial circuit process substitute section 22.

Further, first and second circuit portions 41, 43 of the simulation target, as well as the boundary connection circuit 42 of the simulation target device are provided. Design data 400 is provided for the simulation that includes (but is not limited to) communication unit design data 401, boundary circuits design data 402, and a sub-part of design data 403 for the first circuitry portion 41 of the target simulation device 4. The design data 400 is mapped to each of a plurality of devices (e.g., FPGA) in the emulator 1, such as a boundary circuit 404 for input, a boundary circuit 405 for output, and the host computer communication circuit 12. These are equivalent circuits for the simulation target device 4 (as illustrated in FIG. 4). The boundary circuits 404, 405 are coupled to the host computer communication circuit 12. Boundary circuit information is also stored in the drivers 408 of the host computer 2.

An equivalent circuit 407 to the first circuitry portion 41 of the simulation target device 4 is made by rewritable hardware as described above, based on the sub-part of design data 403 for the first circuitry portion of the emulator 1. The second circuitry portion 43 is simulated by the circuit process substitute 22 of the host computer 2 to execute the equivalent process. Software 406 of the host computer 2 realizes the partial circuit process substitute section 22, the OS caller 23, the OS 24 and the software emulator communicator 408.

Accordingly, the embodiment illustrated in FIG. 4 is configured to delineate boundaries based on the design data 400, and those boundaries can be changed for the next phase of emulation. The change is made depending on what is considered to be variable, as described above. The boundary can be changed so that the software side (i.e., in the host computer 2) can handle various aspects of simulation.

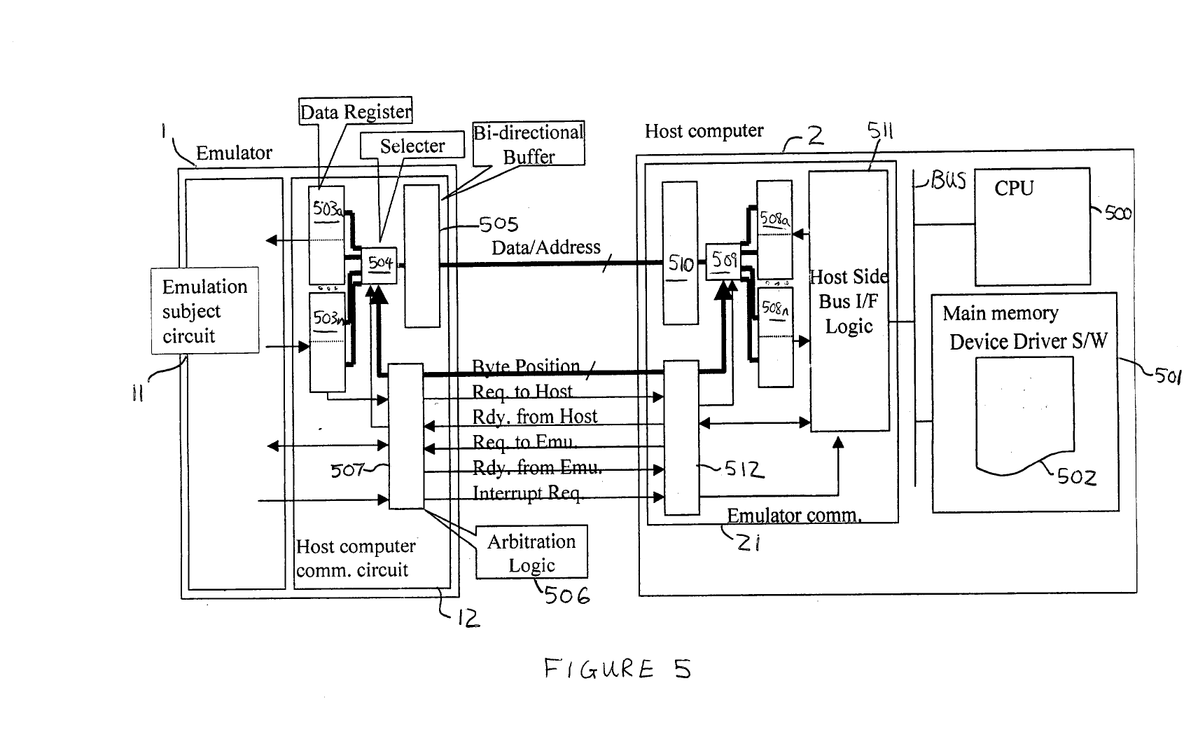

FIG. 5 illustrates an example of implementing communication between the emulator 1 and the host computer 2. In this illustration, only the emulation subject circuit 11 and host computer communication subject 12 of the emulator 1 are shown, for the purposes of explanation. Similarly, only the emulator communicator 21 and a bus BUS linking the emulator communicator 21 with the CPU 500 and a device driver 502 in a main memory 501 are shown. However, other portions of the emulator 1 and host computer 2 may also be present in the emulator 1 depicted in FIG. 5.

The host computer communication circuit 12 includes a data registers 503a, 503n respectively transmitting to and from the emulation subject circuit 11. The data registers 503a, 503n transmit the data via a selector 504. The selector 504 is coupled to a bi-directional buffer 505 that communicates data/address information to and from the host computer 2. Additionally, arbitration logic 506 is provided, which, via a bi-directional buffer 507 arbitrates data communication with at least the following communications with the host computer 2: byte position, request to host, ready from host, request to emulate, ready from, emulator, and interrupt request.

Similarly, the emulator communicator 21 of the host computer 2 communicates with the emulator 1. For example, but not by way of limitation, data registers 508a, 508n communicate data to and from the emulator 1 via a selector 509 and a bi-directional buffer 510. The data registers 508a, 508n communicate with host-side logic 511, preferably in the hardware interface. The host-side logic 511 also performs arbitration for the host computer 2 via a bi-directional buffer 512.

Various tasks are performed by the communication circuits illustrated in FIG. 5. For example, but no by way of limitation, on the side of emulator, mapping with the target circuit of simulation is performed. From the software simulation side, the I/F board (i.e., hardware) and device driver (i.e., software) are used. Also, the communication circuit of FIG. 5 can be used to perform arbitration of data transmission rights, and transfer data bi-directionally.

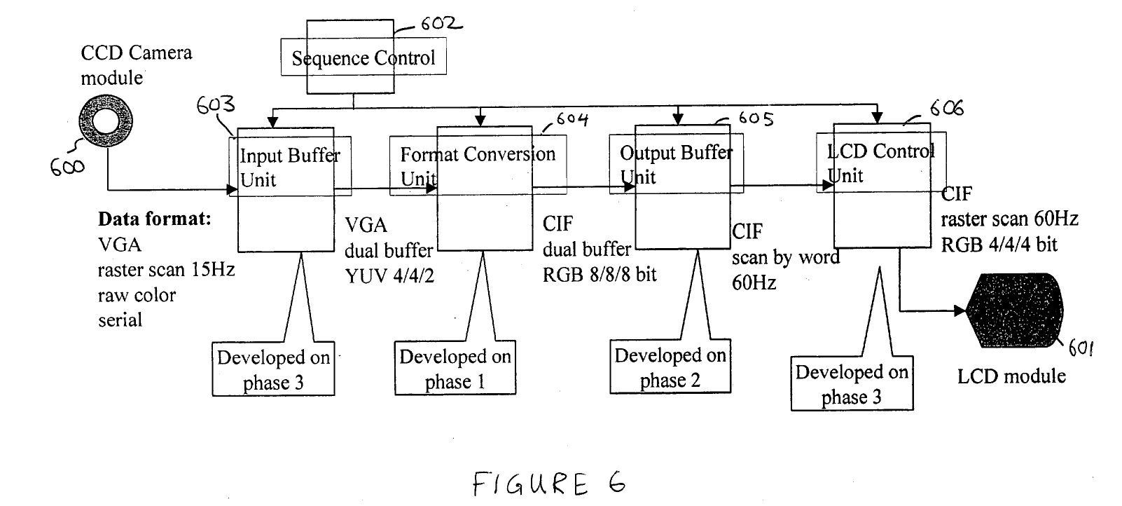

FIG. 6 illustrates an example of an application target for which the simulation can be performed according to an exemplary, non-limiting embodiment of the present invention (i.e., simulation target device 4). In this application, an input from a charge coupled device (CCD) camera 600, having a video graphics array (VGA) data format with a raster scan frequency of 15 Hz and input raw color in serial transmission mode, is output to a liquid crystal display (LCD) module 601, having a common intermediate format (CIF) with a raster scan frequency of 60 Hz and a non-encoded red-green-blue (RGB) color scheme, transmitted in 4/4/4 bit transmission mode.

To perform this conversion, the data from the CCD camera 600 is sent to an input buffer unit 603, where the data is converted from the raw color input in serial data transmission to a dual buffered block data transmission format, with a YUV (i.e., separate luminance and chrominance) color scheme in 4/4/2 bit transmission mode. The data is buffered in the input buffer unit 603, still in its initial VGA data format.

The output of the input buffer unit 603 is then transmitted to a format conversion unit 604, where format conversion occurs. The data format is converted from VGA to CIF, and the color coding scheme is converted from the YUV encoded 4/4/2 bit scheme to a RGB 8/8/8 bit scheme. The data is in the dual buffered block data format.

Once the format conversion unit 604 has converted the data, the resulting data is transmitted to an output buffer unit 605, where the data is stored in CIF. The data is output by the output buffer unit 605 in CIF at a raster scan frequency of 60 Hz. Further, the data is output in scan-by-word format.

An LCD control unit 606 receives the output of the output buffer unit 605, and outputs the data to the LCD module 601 in CIF format at the raster scan frequency of 60 Hz, with the color format of RGB in a 4/4/4 bit scheme. The movement of data in units 603-606 is controlled by a sequence control unit 602. As a result, data is converted from a format used in the CCD camera 600 to a format used in the LCD module 601.

To simulate the above-described simulation target device, the system illustrated in FIG. 6 is developed in three phases. In a first phase, the format conversion unit 604 is developed, followed by the development of the output buffer unit 605 in a second phase. In a third phase, the input buffer unit 603 and the LCD control unit 606 is developed.

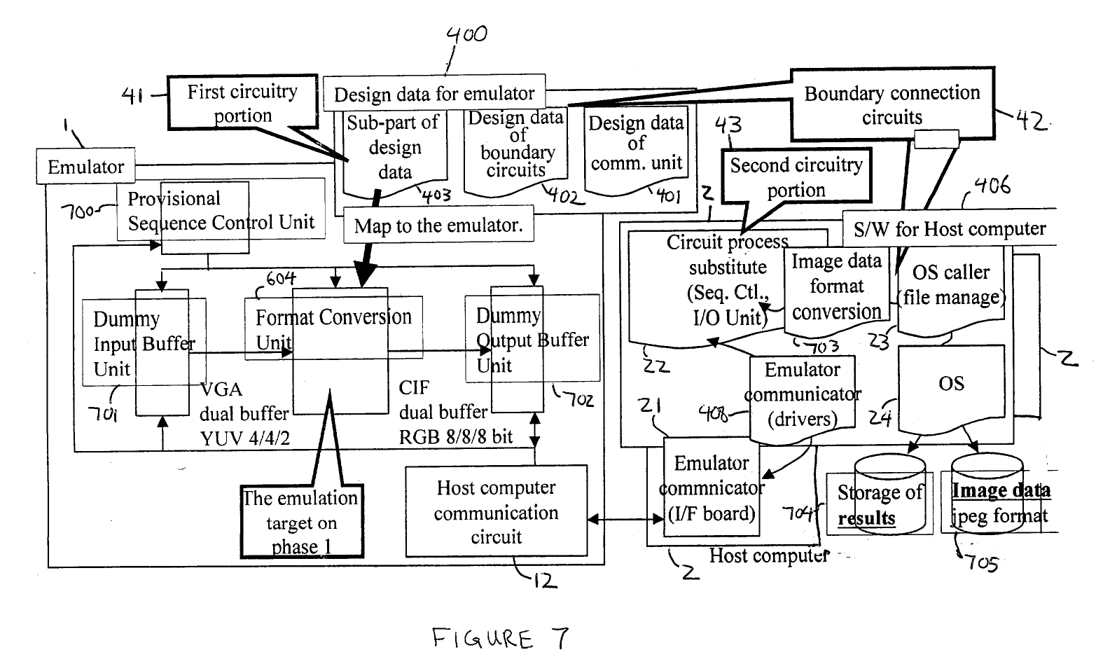

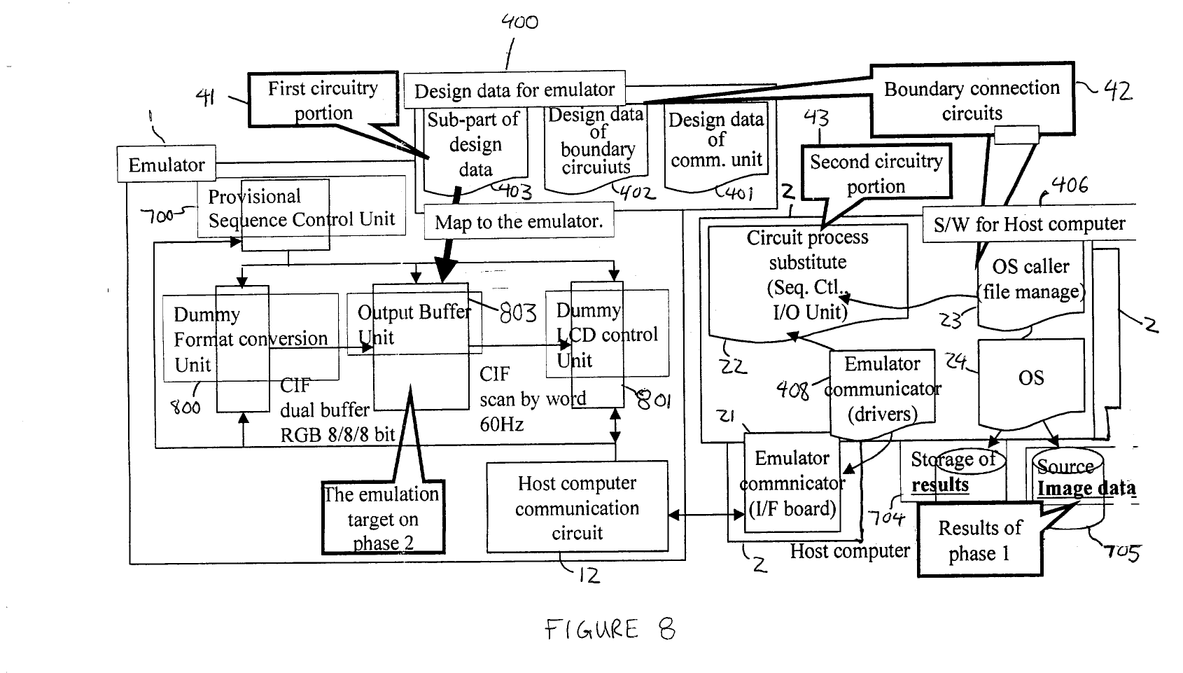

FIGS. 7 and 8 illustrate an example of the first phase and the second phase of simulation, respectively, for the application illustrated in FIG. 6. FIGS. 7 and 8 illustrate a similar structures to FIG. 4, with the application to phase 1 of the development of the system illustrated in FIG. 6.

In the first phase illustrated in FIG. 7, the data structure is input/output directly with the software side, as there is no need for the data to directly correspond with the data structure of the circuit which is to be finally mounted. For example, but not by way of limitation, the first phase is designed to handle in the software side such aspects as conversion between raster scan data and a joint photographic experts group (JPEG) format.

Accordingly, a provisional sequence control unit 700 equivalent to the sequence control unit 602 is included in the emulator 1, to emulate control of the data flow process. The boundary circuit for input in this first phase is a dummy input buffer unit 701 equivalent to the buffer input unit 603. The dummy input buffer unit 701 outputs the data to the format conversion unit 604, which is the target device of the simulation performed in the first phase of development. The output of the format conversion unit 604 is sent to a dummy output buffer unit 702, which is equivalent to the output buffer unit 605.

As illustrated in FIG. 7, the image data format conversion described above occurs in the software 406 in an image data format converter 703. The results of the simulation are stored in a first storage unit 704, and the image data (e.g., converted from raster scan data to JPEG format by converter 703 of the software 406) is stored in a second storage unit 705. The first and second storage units 704, 705 correspond to the input/output devices 31, 32 as described above.

As a result of the first phase of development described above and illustrated in FIG. 7, the format conversion unit 604 of FIG. 6 is emulated using the exemplary, non-limiting embodiment of the present invention. As a result, data format is converted from VGA to CIF, and the encoding scheme is converted from YUV 4/4/2 to RGB 8/8/8. As described below, the present invention can apply results of the simulation in the first phase to the simulation to be performed in the second phase.

FIG. 8 illustrates an exemplary, non-limiting embodiment showing the second phase of development of the application illustrated in FIG. 6. In the second phase, the output unit buffer 605 is the target device of the simulation. In this phase, it is possible to divert output data that is obtained in the evaluation of the input circuit for an evaluation of the circuit in the next step. For example, but not by way of limitation, the data generated as a result of the first phase of development as illustrated in FIG. 7 (i.e., converted source image data stored in the second storage unit 705) and described above may also be used in the second phase to develop and simulate the output buffer unit 605.

The description of the features of FIG. 8 bearing the same reference characters as those of FIGS. 4-7, and which are substantially the same as those features, is not repeated here. In the second phase, the boundary circuit for input is a dummy format conversion unit 800, and its output is transmitted to the output buffer unit 803, which is the equivalent of the target device of simulation (output buffer unit 605) in the second phase. The equivalent output buffer unit 803 is constructed by rewritable hardware in the emulator 1. The output of the output buffer unit 803 is transmitted to a dummy LCD control unit 801, which is equivalent to the dummy control unit 606. Accordingly, the output buffer unit 605 is emulated in the emulator 1 with the assistance of the host computer 2. Further, the boundary is shifted between the first phase and the second phase to correspond to the use of the results of the first phase, which are stored in the second storage unit 705 of the host computer 2.

As a result of the first phase of development described above and illustrated in FIG. 8, the output buffer unit 605 of FIG. 6 is emulated using the exemplary, non-limiting embodiment of the present invention. As a result, the scan frequency is converted from 15 Hz to 60 Hz, and the data is available in a scan by word format for the LCD control unit 606.

In a manner similar to the above-described implementation in FIGS. 7 and 8, a third phase can be performed for the target apparatus of FIG. 6. In the third phase, the input buffer unit 603 and the LCD control unit 606 are emulated, and the data is modified as described above with respect to the operation of the apparatus of FIG. 6.

As described above, the present invention provides a communication means for sending and receiving data required for the simulation between the emulation subject circuit and the partial circuit process substitute section. Therefore, the boundary between the first circuitry portion emulated by the emulation subject circuit and the second circuitry portion simulated by the partial circuit process substitute section can be freely adjusted. That is, every time a new additional specification is decided, the structure for emulating the element whose specification is newly decided can be added to the emulator subject circuit, making the system level simulation efficient.

Further, the emulator subject circuit with the rewritable hardware such as an FPGA, emulates the element whose specification is fixed, thus increasing the processing speed.

Furthermore, the OS simulates the input/output operation of the second circuitry portion, simplifying the structure of the partial circuit process substitute section.

This invention may be embodied in other forms or carried out in other ways without departing from the spirit thereof. The present embodiments are therefore to be considered in all respects illustrative and not limiting, the scope of the invention being indicated by the appended claims, and all modifications falling within the meaning and range of equivalency are intended to be embraced therein.

What is claimed is:

1. A system level simulation method for simulating a target device, comprising the steps of:
dividing said target device into a first circuitry portion and a second circuitry portion;
emulating only said first circuitry portion by an emulation subject circuit constructed by rewritable hardware;
simulating only said second circuitry portion by a partial circuit process substitute section constructed by software; and
allowing communication of data between said emulation subject circuit and said partial process substitute section.

2. A method according to claim 1, further comprising the step of:
calling an operating system from said partial circuit process substitute section; and
simulating the input/output process of only said second circuitry portion using said operating system.

3. A method according to the claim 1, wherein said rewritable hardware is an FPGA.

4. A system level simulation device for simulating a target device, comprising:
an emulation subject for emulating only a first circuitry portion in said target device, said emulation subject circuit being constructed by a rewritable hardware;
a partial circuit process substitute section for simulating only a second circuitry portion in said target device, said partial circuit process substitute section being constructed by software; and
a communicator for transmitting data required for the simulation between said emulation subject circuit and said partial circuit process substitute section.

5. A device according to claim 4, further comprising:
an operating system caller for calling an operating system which simulates the input/output process performed by only said second circuitry portion.

6. A device according to claim 5, wherein said rewritable hardware is an FPGA.

7. A computer readable medium containing program instructions for simulating a target device, the program instructions for performing the steps comprising:
dividing said target device into a first circuitry portion and a second circuitry portion;
emulating only said first circuitry portion by an emulation subject circuit constructed by a rewritable hardware;
simulating only said second circuitry portion by a partial circuit process substitute section constructed by software; and
allowing communication of data between said emulation subject circuit and said partial process substitute section by a communicator.

8. A computer readable medium according to claim 7, wherein the program instructions include instructions for performing the step of providing said partial circuit process substitute section and said communicator in a computer by software.

9. The method of claim 1, wherein said emulating and said simulating are performed simultaneously.

10. The method of claim 1, wherein said dividing step divides said target device into said first circuitry portion if a specification of said target device is fixed and into said second circuitry portion if said specification of said target device is not fixed.

11. The method of claim 1, wherein said first circuitry portion is mutually exclusive with respect to said second circuitry portion.

12. The device of claim 4, wherein said emulation subject circuit and said partial circuit process section operate simultaneously.

13. The device of claim 4, wherein said first circuitry portion comprises a portion of said target device that having a specification that is fixed, and said second circuitry portion comprises a portion of said target device having said specification that is not fixed.

14. The device of claim 4, wherein said first circuitry portion is mutually exclusive with respect to said second circuitry portion.

15. The computer readable medium of claim 7, wherein said emulating and said simulating are performed simultaneously.

16. The computer readable medium of claim 7, wherein said target device is divided into said first circuitry portion if a specification of said target device is fixed and into said second circuitry portion if said specification of said target device is not fixed.

17. The computer readable medium of claim 7, wherein said first circuitry portion is mutually exclusive with respect to said second circuitry portion.
